(19) United States
(12) Patent Application Publication
(10) Pub. No.: US 2025/0230907 A1
(43) Pub. Date: Jul. 17, 2025

(54) MODULAR HANGING LIGHT FIXTURE

(71) Applicant: 3form, LLC, Salt Lake City, UT (US)

(72) Inventors: Edwin A. Vice, JR., Seattle, WA (US); Bryce C. Anderson, Renton, WA (US)

(21) Appl. No.: 19/017,405

(22) Filed: Jan. 10, 2025

Related U.S. Application Data
(60) Provisional application No. 63/620,662, filed on Jan. 12, 2024.

(51) Int. Cl. F21S 2/00; F21S 8/06; F21V 15/015; F21V 21/008; F21V 21/34; F21V 23/00; F21Y 115/10

(52) U.S. Cl. CPC F21S 2/005; F21S 8/061; F21V 15/015; F21V 21/008; F21V 21/34; F21V 23/001; F21Y 2115/10

(57) ABSTRACT

A modular light fixture has a track suspended from cables attached to a ceiling. The cables are attached to a coupler that can slide along the track and affix to a plurality of positions continuously along the track. The modular light fixture also includes one or more geometric profiles attached to the track. The geometric profiles contain a light source that illuminates through the geometric profiles. A spacer has the same external dimension as the geometric profiles and is made of the same material. The spacer couples two geometric profiles together seamlessly and without leaking any light between the geometric profiles and the spacer. The spacer may be shaped and sized to enable different connection angles between geometric profiles.

### CROSS-REFERENCE TO RELATED APPLICATIONS

This application claims the benefit of and priority to U.S. Provisional Application No. 63/620,662, entitled MODULAR HANGING LIGHT FIXTURE, filed on Jan. 12, 2024, the entirety of which is incorporated herein by reference.

### BACKGROUND

### 1. Technical Field

This disclosure relates to systems, methods, and devices for providing illumination. In particular, this disclosure relates to modular lighting systems and devices that may be utilized to form low-volume, modular light assemblies.

### 2. Background and Relevant Art

Limitations to such modular lighting systems include the formation of unsightly gaps or seams between two adjacent modules at the site of coupling, which may detract from the aesthetic appeal or the functionality of such lighting assemblies. Moreover, a typical lighting module may involve the use of several pieces of connective and/or mounting hardware in order to properly couple modules together and to mount the completed assembly, such as to a wall or ceiling. Such connective and/or mounting hardware may be bulky and hence detract from the look and operability of such lighting assemblies.

Furthermore, light fixture assemblies tend to be manufactured in limited patterns for a given line of products at least in part due to the cost associated with customizing various shapes and alignments of sub-components. On the other hand, highly customized projects tend to involve much higher manufacturing costs. Such customizations may be no more than variations in angles between various geometric profiles.

In addition, ease of assembly is hampered by the often-complicated coupling and/or mounting requirements, making it difficult to quickly arrange lighting modules into a desired.

Accordingly, there are a number of disadvantages in the art that can be addressed.

### BRIEF SUMMARY

The present disclosure is directed to a modular light fixture system that is capable of being assembled in a wide variety of shapes and dimensions, and may be hung with a high degree of flexibility corresponding to the structure of a given environment. For example, a modular light fixture can comprise a plurality of geometric profiles that can be joined together by a spacer and a track connector. The track and track connector can take on any number of shapes and angles to ensure a high degree of angle configurability between geometric profiles while also minimizing leakage of light between seams. Moreover, a flexible track system enables hanging hardware to be flexibly positioned along the light fixture to ensure that the light fixture can be mounted anywhere there is structural support.

For example, at least one embodiment of the present invention comprises a modular light fixture having a first track with an upper surface, a lower surface, and a mounting gap along the upper surface. The modular light fixture can also include a cable, and cable coupler that can be slidably positioned within the mounting gap. In one example, the coupler is configured in size and shape to slide along the first track in the mounting gap to adjust a position of the coupler relative to the first track. The modular light fixture also includes a plurality of geometric profiles fastened to the lower surface of the track, the geometric profile housing a light source, and a track connector having a first end and a second end. The track connector fits within the gap of the first track on one end, and fits within a similar gap corresponding second track of a second geometric profile. The first and second tracks are aligned in an end-to-end configuration.

Further embodiments comprise a modular light fixture that includes a first geometric profile having a generally uniform cross-sectional shape and a generally hollow interior, and a second geometric profile having a generally uniform cross-sectional shape and a generally hollow interior. The modular light fixture also includes a first light source in the first geometric profile, a second light source in the second geometric profile, and a spacer between the first geometric profile and the second geometric profile. The spacer has a flange with an exterior dimension that substantially matches the cross-sectional shape of the first geometric profile and the second geometric profile; the spacer further includes a first plug extending toward the first geometric profile.

In one embodiment, the first plug of the spacer can be coupled to the first geometric profile, with an exterior surface of the flange of the spacer being flush with an exterior surface of the first geometric profile, and with the first plug fitting within the hollow interior of the first geometric profile. The modular light fixture also includes a second plug on an opposing side of the spacer, the second plug extending toward the second geometric profile that is coupled to the second geometric profile with an exterior surface of the flange flush with an exterior surface of the first geometric profile, and with the second plug fitting within the hollow interior of the second geometric profile. The spacer can provide a seamless look and feel to the connected geometric profiles while inhibiting leakage of light between seams. The modular light fixture also includes a power source coupled to the first and second light source and being configured to illuminate through the first and second geometric profiles, or first illuminated geometric profile and the second illuminated geometric profile.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific implementations thereof which are illustrated in the appended drawings. Understanding that these drawings depict only typical implementations of the invention and are not therefore to be considered to be limiting of its scope, the invention will be described and explained with additional specificity and detail through the use of the accompanying drawings in which:

FIG. 1 is a front view of a modular light fixture according to the present disclosure;

FIG. 2 is an isometric view of a track for a modular light fixture according to embodiments of the present disclosure;

FIG. 3 is an end view of the track according to embodiments of the present disclosure;

FIG. 4 is an end view of a modular lighting fixture according to embodiments of the present disclosure;

FIG. 5 is an isometric elevation view of an illuminated geometric profile according to embodiments of the present disclosure;

FIG. 6 is an isometric view of a track connector for use with the modular light fixture of the present disclosure;

FIG. 7 is an end view of the track and track connector according to embodiments of the present disclosure;

FIG. 8 is a side view of a track connector and two tracks for modular light fixtures of the present disclosure;

FIG. 9A is a top view of a track connector according to embodiments of the present disclosure;

FIG. 9B is a top view of a track connector according to embodiments of the present disclosure;

FIG. 10 is a front view of a modular light fixture, including a spacer that couples two illuminated geometric profiles together according to embodiments of the present disclosure;

FIG. 11 is an isometric view of a spacer according to embodiments of the present disclosure;

FIG. 12 is a schematic view of a spacer, a first illuminated geometric profile, and a second illuminated geometric profile according to embodiments of the present disclosure;

FIG. 13 is a side view of a spacer according to embodiments of the present disclosure;

FIG. 14 is a side view of an angled spacer according to embodiments of the present disclosure;

FIG. 15 is a side view of an assembled modular light fixture according to embodiments of the present disclosure; and

FIG. 16 is a top-down facing perspective views of track connectors of different angles.

### DETAILED DESCRIPTION

The present disclosure is directed to modular light fixtures that hang from a ceiling in an interior space of a building; the fixtures may alternatively be surface, track, frame, or wall-mounted. The modular light fixtures of the present disclosure include a track that is an elongated, thin, rigid piece of material with a cross-sectional profile that allows for easy hanging of the light fixture, such as when mounted to a ceiling. The track includes two parallel rails that are generally flat on a top side and on a bottom side. The rails are joined together by a bridge that is also elongated and generally flat and connects to the bottom side of the rails. The space between the rails and the bridge is a gap that runs along the length of the track. The gap receives a fastener (e.g., cable coupler), cable, pin, or other connection device that connects the track to a ceiling in a building.

The gap can be generally uniform along the length of the track and can therefore receive the fastener (cable coupler) at any position along its length. In some embodiments, the fastener includes a release mechanism such as a threaded engagement or a biased engagement to maintain the fastener in place relative to the track. Releasing the release mechanism allows the fastener to slide along the gap to a different location. This flexibility is valuable and allows the light fixture to be precisely placed even when the cable that holds the light fixture is imprecisely located whether due to the constraints of the structure or due to operator error.

The lighting fixture can also include a plurality of geometric profiles that are connected to the track, and generally of an elongated shape having an essentially hollow interior (apart from a few structural, functional components). The geometric profile interfaces with the track, such that the geometric profile is underneath the track and fastened to the track. A light source such as an LED strip can be positioned inside the geometric profile. The geometric profile is at least partially translucent or even transparent in some cases, and can have light transmissivity properties that create a desirable, aesthetically pleasing color and tone of light from the light source within the geometric profile. In some embodiments the geometric profile has a generally square cross-sectional shape constructed of walls having a generally uniform thickness. The geometric profile can have an opening at a top side of the geometric profile that can receive the track and facilitate connection of the track and the geometric profile.

The modularity of the light fixture is two-fold. First, two or more tracks can be joined together end-to-end to create a light fixture that can be as long as needed. A track connector can have a shape that fits within the gap in a first track with approximately half of the track connector protruding from the first track. A second track can be connected by inserting the protruding second half of the track connector into the gap of the second track. Third and fourth tracks and more can be connected in the same way to achieve a light fixture of a desired length.

In some embodiments the track connector is straight, and the tracks are connected in a parallel arrangement with an angle between the first track and the second track being zero. In other embodiments an angled track connector can provide an angle between a first track and its associated geometric profile and a second track and its associated geometric profile. The angle can be any desired angle, and the length of the tracks and geometric profiles can vary, yielding an enormous degree of customization and design to suit any interior space in a beautiful, expressive way.

The second modular aspect of the present disclosure is between the geometric profiles of adjacent light fixture units. The geometric profiles can have any desired shape, but to illustrate aspects of the present disclosure the geometric profile can be a square, hollow, elongated member having a generally uniform cross-sectional shape along its length. The geometric profiles in an array can have the same cross-sectional shape such that aligning them end-to-end results in a flush fit between the two adjacent geometric profiles.

To join two adjacent geometric profiles, an assembler can employ a spacer that interfaces with each geometric profile to create a seamless fit that does not permit light to escape, and appears to be a uniform, solid construction. The spacer can be symmetrical about its center axis that defines a flange that has an exterior dimension generally equal to the exterior dimension of the geometric profiles. For example, if the geometric profiles are 2″×2″ squares, the shape of the flange is 2″×2.″ The spacer also includes a plug on each side that fits within the geometric profiles and creates a secure fit which may be a friction fit. The size of the plug is generally equal to the size of the interior hollow space of the geometric profiles. For example, if the walls of the 2″×2″ geometric profile are ⅛″ then the plug is a square that is 1.75″×1.75″ and the plug on each side fits snugly within the hollow interior of each corresponding geometric profile.

The spacer can be made of a material having complimentary light-transmissivity characteristics as the geometric profiles. In some cases, the spacer is made of the same material as the geometric profiles. The snug fit between the flange, plug, and hollow interior of the geometric profile prevents light from shining through the gap which creates the appearance of the geometric profiles being integrally formed, regardless of the number of bends and alternate angles between profiles that are employed.

In some embodiments, the spacer can be a linear spacer that enables two geometric profiles to be aligned in a straight, parallel configuration. In other embodiments that call for an angle between two adjacent geometric profiles, the spacer can be an angled spacer. The plugs of an angled spacer may be the same as they are for the linear spacer, but the flange in the center is different. In some embodiments the flange is a body that has an angle that spans between the two geometric profiles. The spacers may be hollow and can therefore form a continuous passage from the first geometric profile, through the spacer, and into the second geometric profile.

The modular light fixture of the present disclosure can be constructed on any length, with sections linked together at any angle (with the track connector) to form a wide variety of shapes and designs. The angles between tracks and the corresponding geometric profiles can vary to achieve different shapes. In some embodiments the geometric profiles are all at the same elevation relative to the ceiling from which the modular light fixture hangs. In other embodiments the angled connection between tracks and geometric profiles can be in the vertical direction.

One or more of the modular light units can be level with the floor, and one or more of the modular light units can slope upward or downward. In some embodiments the modular light units can have geometric profiles of different shapes and can include a transition geometric profile, such as an angled, or triangular profile, to enable transitions between the shapes. For example, one geometric profile can be square, and a second geometric profile can be round. The geometric profile (or alternatively, a differently shaped spacer) between them can provide a transition from a square side to the round side. The flange and plugs for the alternate geometric profile or spacer can be correspondingly shaped to make the transition. The track connector can also be angled upward or downward in the same angle as the spacer that is used between the two geometric profiles.

The continuous gap and fastener connection of the cable coupler 126 allows the connection point to a suspending cable 108 to move to any desired location along the track 102, which allows for some imprecision in the location of the supporting cable and/or electrical line. The structure of the geometric profiles achieves a uniform, seamless construction that does not leak light at the corners.

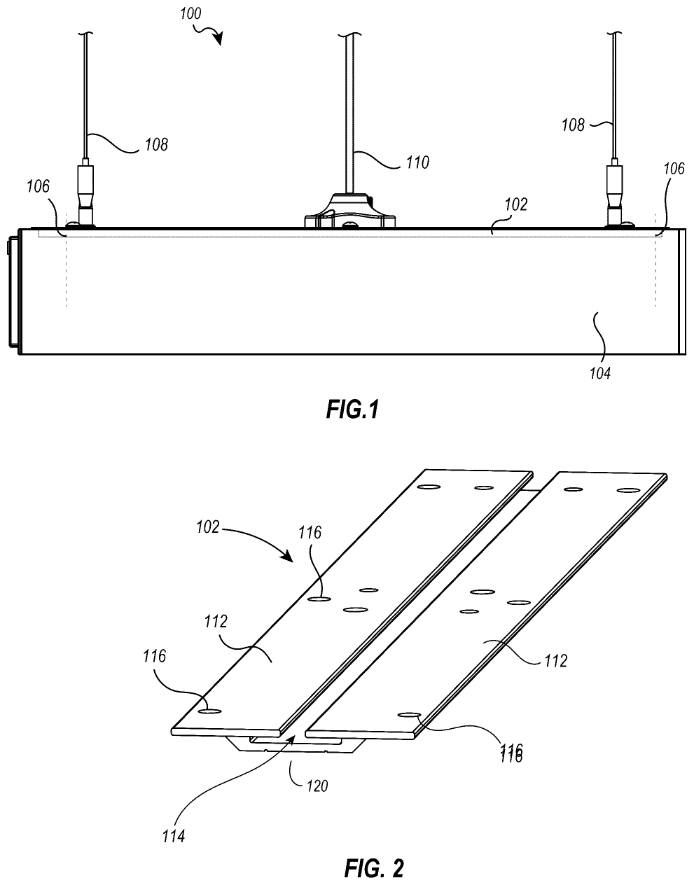

Referring now to the Figures, FIG. 1 is a front view of a modular light fixture 100 according to the present disclosure. The modular light fixture 100 includes a track 102 that comprises an elongated, rigid piece of material having a generally uniform cross-sectional shape. The modular light fixture 100 also includes a geometric profile 104 that is coupled to track 102. The geometric profile will generally comprise a translucent or transparent resin material, such as but not limited to PETG, PET, Acrylic, PMMA, polycarbonate, or mixtures thereof.

In some embodiments, the geometric profile 104 can be suspended from track 102 and hang downward from track 102. In other embodiments, the geometric profile 104 can be positioned above track 102. In still other embodiments, geometric profile 104 is positioned behind track 102 or in front of track 102, in which cases the track 102 may be rotated to align with a surface of the geometric profile 104 that is coupled to track 102. For example, an assembler can secure track 102 to a wall in a vertical orientation. In such an example, geometric profile 104 would be positioned on the side or in front of track 102.

In some embodiments, the geometric profile 104 is a hollow, elongated member constructed of a material with light-transmissivity characteristics appropriate for a given design. One such material can be a translucent acrylic material that is at least partly translucent and able to broadly diffuse light. The shape of the geometric profile 104 may vary. For example, the shape can be square, round, eccentric, oval, or any other suitable shape. In some embodiments, the geometric profile 104 has a generally uniform cross-sectional shape, while in other embodiments, the shape may vary along the length of the geometric profile 104. For example, one such non-uniform cross-sectional shape configuration can be a square spiral shape where, at the ends, the square has a top and bottom level with the ground, but between the ends, the corners spiral around pleasingly. In other embodiments, the geometric profile 104 can be curved or jagged or can have a combination of straight and curved shapes.

FIG. 1 also shows that track 102 can be secured to geometric profile 104 via fasteners 106. Fasteners 106 can be screws or rivets or a friction fit interface that secures geometric profile 104 to track 102. In the depicted embodiment, the fasteners 106 are shown in phantom lines in a partially exploded view. In some embodiments, track 102 contacts the upper portion of the geometric profile 104 and is generally hidden from view above geometric profile 104. Thus, a viewer of the modular light fixture 100 may not see track 102 as geometric profile 104 can hide it from view when secured to track 102. In some embodiments, the geometric profile 104 can have an opening at its top surface, and an assembler can place track 102 within the opening.

Track 102 and geometric profile 104 together can be a modular light unit. An assembler may put together two or more of these light units (geometric profiles) in an end-to-end configuration, such as shown and described herein in greater detail below, jointed together at least in part by the track connector and the spacer.

For example, as shown in FIG. 1, modular light fixture 100 can include cables 108 that are fastened to track 102 or geometric profile 104 and suspend the modular light fixture 100 from a ceiling or other overhead structure. Cables 108 can be attached via cable couplers 126 that are slidable along track 102, and then securable when in an appropriate position. The modular light fixture 100 also includes a cord 110 that provides an electrical signal to the modular light fixture 100. In at least one embodiment, an assembler can install cord 110 along, inside, or adjacent to cable 108. Geometric profile 104 can have a light source inside that can be an incandescent bulb, a light-emitting diode (LED), or another suitable light source. In some embodiments, the light source is an LED strip placed inside geometric profile 104, which receives energy from the cord 110. A control unit (not shown) can facilitate distributing the power to the light source within geometric profile 104. The control unit can manage the light source by turning on or off the light source, changing intensity (a dimmer), or changing color.

FIG. 2 is an isometric view of track 102 for a modular light fixture according to embodiments of the present disclosure. As shown, track 102 can include two rails 112 that are generally flat, elongated members that extend the length of geometric profile 104. Rails 112 can be where an assembler secured geometric profile 103 to track 102. Rails 112 are spaced apart, relative to each other, by a certain distance to form a gap 114 that is continuous along its length. Rails 112 can each include holes 116 at various locations, which an assembler can use to secure the track 102 to the geometric profile 104. Holes 116 can be threaded. A manufacturer can include a countersink on either side of hole 116.

FIG. 2 further shows that track 102 can include a bridge 120. Bridge 120 generally comprises an elongated member connected to both of the rails 112 on the bottom or bottom face of rails 112. Bridge 120 can be formed of a material different from rails 112 and fastened to rails 112. In other embodiments, track 102 is a monolithic construction, and a manufacturer form rails 112 and bridge 120 together as one singular member using an extrusion process.

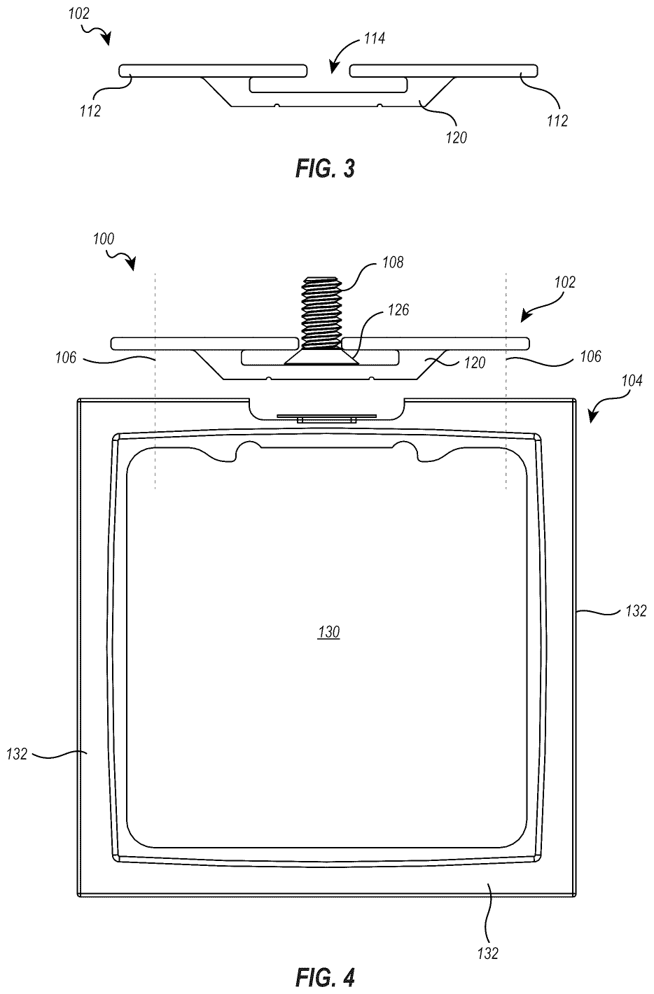

FIG. 3 is an end view of track 102 according to embodiments of the present disclosure, which further shows rails 112, bridge 120, and gap 114. Gap 114 can have a T-shaped profile (or inverted T-shape) that can receive a cable coupler 126 (see FIG. 4) to secure a cable 108 to track 102. The rails 112 may be identical in dimension, and the bridge 120 can be symmetrical. Track 102 can be substantially thin in the vertical direction to allow track 102 to be hidden by a geometric profile to which track 102 is secured.

FIG. 4 is an end view of a modular lighting fixture 100 according to embodiments of the present disclosure. Track 102 and geometric profile 104 are shown in a partially exploded view, with fasteners 106 holding track 102 to geometric profile 104. Fasteners 106 can be placed within holes 116, as shown in FIG. 2. Cable 108 is partially shown and can suspend the modular light fixture 100 from a ceiling or other overhead structure. Cable 108 can include a cable coupler 126, which fits within the gap 114 of the track 102. As shown, in at least one embodiment, at least a portion of cable 108 can extend into gap 114, while in another embodiment, no portion of cable 108 extends into gap 114.

The cable coupler 126 can include a release mechanism that allows the cable coupler 126 to slide along the gap to adjust the position of cable 108 relative to the modular light fixture 100. The release mechanism can include a biasing member that expands the cable coupler 126 within track 102 and releases when an installer grasps the cable coupler 126 to reposition the cable coupler 126. In other embodiments, the release mechanism can be a threaded member that, when rotated, secures the cable 108 to track 102 but can be rotated oppositely to at least partly release the grip with the track and enable sliding. It should be noted that in one embodiment, cable coupler 126 can extend upward and outside of gap 114. Further, in at least one embodiment, cable coupler 126 has a threaded receiver configured to receive a threaded member of cable 108.

FIG. 4 also shows that geometric profile 104 can have a square cross-sectional shape with a hollow interior 130, according to embodiments of the present disclosure. Geometric profile 104 includes walls 132 that have a generally uniform thickness. Geometric profile 104 can be made of a translucent acrylic material or other material that has desirable light transmissivity characteristics.

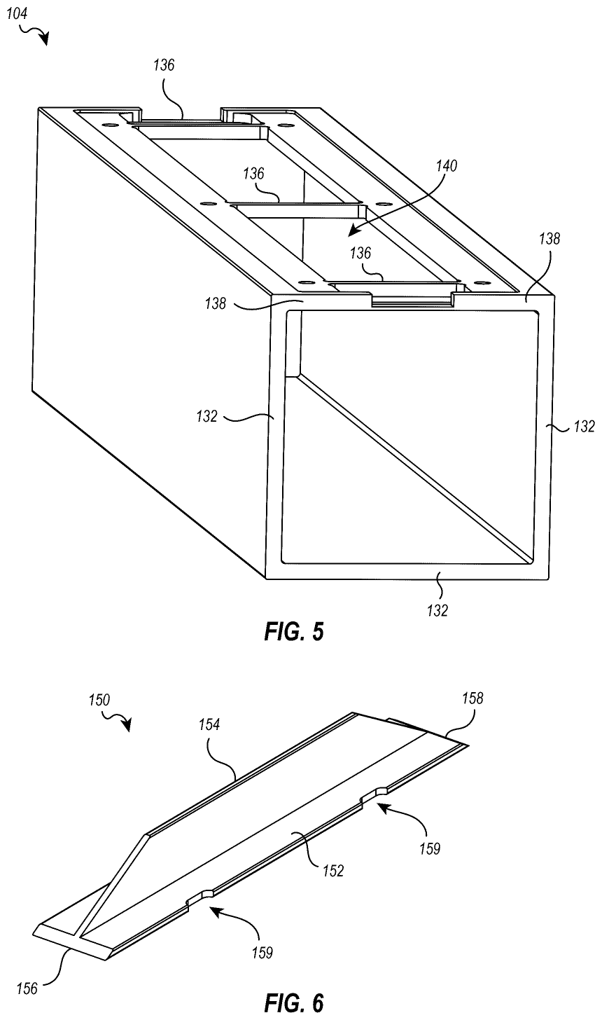

FIG. 5 is an isometric, elevation view of a geometric profile 104 according to embodiments of the present disclosure. As shown, the walls 132 of the geometric profile 104 form a square cross-sectional shape that is generally uniform along the length of the geometric profile 104. Geometric profile 104 can include an opening 140 through the top of the geometric profile 104. Opening 140 can receive a track within, whether fully or partially.

In some embodiments, the track fits within opening 140, and is wider than the opening such that the geometric profile 104 rests on an upper surface of the track with portions of the top wall 138 contacting the top of the track. FIG. 5 also shows supports 136 that span the opening at various locations along the length of geometric profile 104 and provide both structural stability and possible additional mounting trusses for other hardware. Supports 136 can be selectively securable to geometric profile 104, allowing an assembler to attach or detach them, or they can be part of geometric profile 104. In at least one embodiment, the supports 136 can be used to secure the geometric profile 104 to the track 102.

FIG. 6 is an isometric view of track connector 150 for use with the modular light fixtures of the present disclosure. Track connector 150 has a plate 152, which can be generally flat and thin, and a tab 154, which protrudes perpendicularly to and upward from plate 152. Tab 154 may also be flat and thin. In some embodiments, track connector 150 is formed using an extrusion process that creates a plastic or synthetic track connector. In other embodiments, track connector 150 is made of two stamped metal sheets and then joined using an adhesive or a weld. Tab 154 protrudes from the center of plate 152 and can have sloped or tapered ends where the slop connects the top edge of tab 154 to the top surface of plate 152. Plate 152 includes a front edge 156 that can also be sloped or tapered. An assembler will appreciate the inclusion of a slope or taper to front edge 156 as the slope can help insert the track connector 150 into a gap 114 or place relative to the tracks of the modular light fixtures of the present disclosure. A rear edge 158 can be similar to the front edge 156. There are also notches 159 that can engage with a protrusion within the gap for a track to form a more secure fit between the track connector 150 and the track.

Track connector 150 can be inserted into the end of a track and specifically into the gap (e.g., gap 114) of the track. The plate 152 and tab 154 fit within the T-shaped region of the gap. An assembler inserts track connector 150 into a first track, leading with the front edge 156 such that approximately half of the length of track connector 150 is inserted. An assembler can then insert track connector 150 into a second track, leading with the rear edge 158, such that approximately half of track connector 150 is inserted into the second track. The track connector 150, therefore, couples two or more tracks together to form a longer modular light fixture.

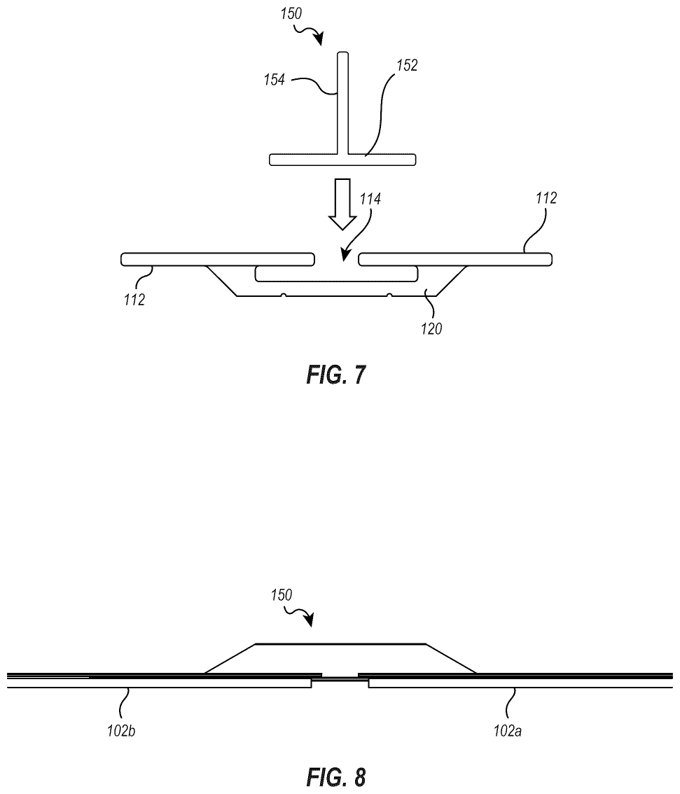

FIG. 7 is an end view of track 102 and track connector 150 according to embodiments of the present disclosure. The rails 112 and bridge 120 form a T-shaped gap 114 that can receive the track connector 150 with the plate 152 within the gap 114 and the tab 154 protruding upward and out of the gap 114.

In some embodiments, the track connector 150 can couple to a cable (not shown) that suspends the modular light fixture from the ceiling or other overhead structure. Cable 108 can connect to tab 154 by way of a fastener. An assembler can slide track connector 150 along the length of track 102. An assembler will appreciate the slidability of the connector 150 as it allows the assembler to align the track connector with a cable that is secured in a ceiling.

FIG. 8 is a side view of a track connector 150 and two tracks 102a and 102b for modular light fixtures of the present disclosure. The track connector 150 is shown inserted into both tracks 102a and 102b. FIG. 8 shows the track connectors inserted slightly less than halfway to show the interface between the two tracks and the track connector. An assembler can push tracks 102a and 102b closer together where they contact one another to provide a continuous, extended track. Thus, the track connector 150 can join two geometric profiles by securing the corresponding tracks together. The track connector 150 can be screwed, pressure fit into a secure position or otherwise secured into the corresponding tracks of each geometric profile. Further, the shape of the track connector 150 can dictate the angle formed between two geometric profiles.

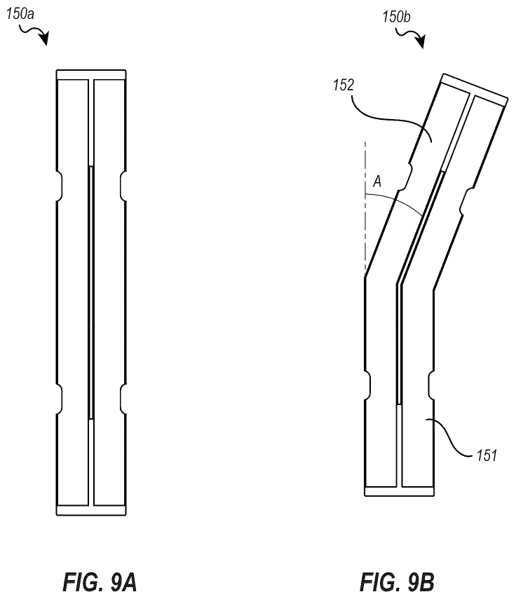

For example, FIG. 9A shows a top view of a track connector 150a according to the embodiments of the present disclosure. Track connector 150a is a linear or substantially straight track connector 150a that, when connecting two tracks together, results in a linear connection such that the tracks and geometric profiles of the modular light units are substantially straight from one end to another (parallel). In contrast, FIG. 9B shows a top view of a track connector 150b according to the embodiments of the present disclosure. The track connector 150b has a predefined angle A, defined by the relation of the first side 151 with the second side 152. The first side 151 can couple to a first track (not shown) and the second side 152 can couple to a second track (not shown). Track connector 150b then can create a modular light unit having an angle between the geometric profiles. Many other angles can be achieved by the track connectors of the present disclosure, including an acute angle, a 90-degree angle, or an obtuse angle, and many variations in between. A manufacturer may only be limited by their manufacturing constraints for angling the shape of the track connector 150.

In some embodiments, the track (e.g. track 102) of a modular light fixture of the present disclosure can alternatively be used as an electrical pathway for the light source of the modular light fixtures. In some embodiments, the track connector (e.g. track connector 150) that couples two modular light units (i.e., two geometric profiles) can also form an electrical pathway between the two tracks. For example, a track connector can include an electrical contact that can fit within a corresponding electrical contact on the tracks to establish the electrical pathway from one modular light unit to the next. An assembler will appreciate the electrical pathway capabilities of the track connector as it removes the need to run additional wires or cables to power or control lights between multiple modular light units.

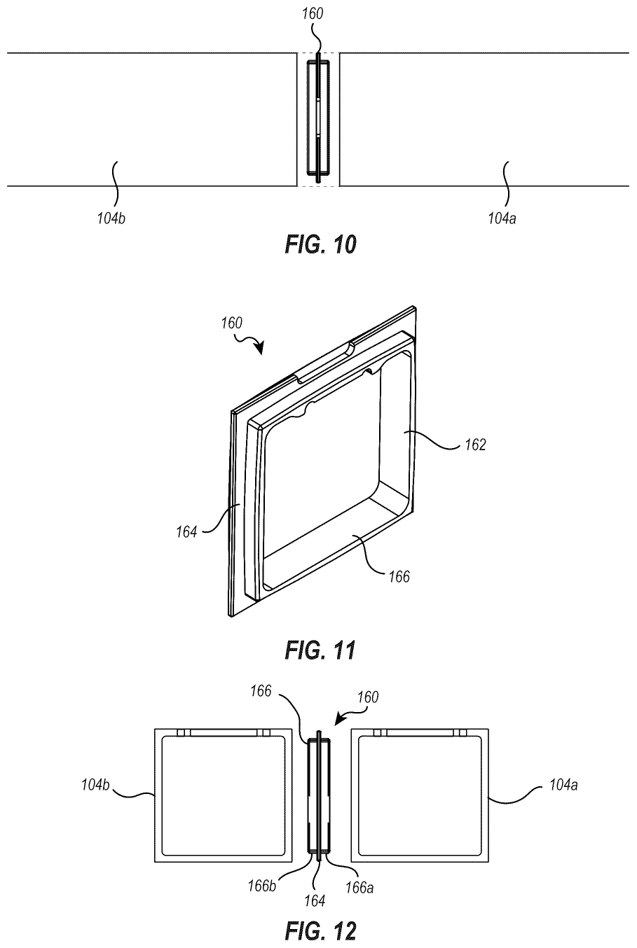

FIG. 10 is a front view of a modular light fixture 100, including a spacer 160 that couples two geometric profiles, 104b and 104a, together according to embodiments of the present disclosure. As previously described, spacer 160 is a piece of material or coupler that fits between two geometric profiles, 104a and 104b, in an end-to-end configuration. Spacer 160 can be made of a material that has the same or at least complementary light transmissivity characteristics as the geometric profiles themselves. Spacer 160 prevents light from leaking from the interface between the spacer 160 and the geometric profiles 104a and 104b, thereby providing a seamless appearance between the joint of two different geometric profiles. When the spacer 160 and geometric profiles 104a and 104b are assembled, the result is the appearance of a seamless, continuous, integral structure for the modular light fixture. A user of a modular light fixture will appreciate the inclusion of a spacer of the present disclosure as it prevents none defused light or a harsher light from leaking out between the geometric profiles and allows the modular light fixture to look like a single light feature rather than a plurality of interrupted light features.

A manufacturer can form the dimensions of spacer 160 relative to the geometric profiles 104a and 104b so that a flush fit is achieved. In some embodiments, the spacer 160, at its largest, is approximately equal to the largest exterior dimension of the geometric profiles 104a and 104b, such that the geometric profiles do not contact one another; rather, the spacer 160 fits between them. Dashed lines 163 and 164 show how the outer-most surface of the geometric profiles 104a and 104b can match up with the outermost edges of spacer 160. In another embodiment, space 160 can be larger than the outermost surface of the geometric profiles.

FIG. 11 is an isometric view of a spacer 160 according to embodiments of the present disclosure. As illustrated, FIG. 11 shows spacer 160 as a linear spacer that is symmetrical about its center plane and can fit between two similar geometric profiles. Spacer 160 is constructed of four 162 walls, which give spacer 160 the square external shape it needs to fit with a square-shaped geometric profile. In other embodiments, the spacer can have a different shape, including triangular, round, pentagonal, etc. In another embodiment, the shape of the spacer 160 and geometric profiles can be any arbitrary shape. In any case, a manufacturer can construct a spacer into any shape that corresponds with the shape of a geometric profile.

Spacer 160 includes a flange 164 that extends around the periphery of spacer 160 and has an exterior dimension that is generally equal to an exterior dimension of a geometric profile. This can enable the exterior surface of flange 164 and the exterior surface of a geometric profile to form a seamless elevation. A user will appreciate the continuous aesthetics from one geometric profile to the spacer and then to a second geometric profile. Spacer 160 can also include a plug 166 (or extension) on a first side of the spacer 160. A similar plug (or extension) can also be on the opposing side. The plug 166 has an exterior dimension that fits within (i.e., extends within) the hollow interior of the geometric profile 102 with a friction fit, a snap fit, or an adhesive fit against the inner face of the walls that make up the geometric profile. The plug 166 can extend into the hollow interior of a geometric profile by a distance approximately equal to the thickness of the walls 162. In other embodiments, plug 166 can extend further into the geometric profile to provide additional strength.

FIG. 12 is a schematic view of a spacer 160, a first geometric profile 104a, and a second geometric profile 104b according to embodiments of the present disclosure. Spacer 160 has a first plug, 166a, and a second plug, 166b. FIG. 12 shows the ends of geometric profiles 104a and 104b to illustrate the interface between plugs 166a and 166b and geometric profiles 104a and 104b, respectively. The depicted geometric profiles 104a and 104b have a square profile that matches the shape of the plugs 166a and 166b. As previously discussed, additional shapes are possible, and the shape of the spacer 160 and plugs 166a and 166b can match.

In some embodiments, geometric profiles 104a and 104b can include a recess that receives the plugs 166a and 166b. An interior hollow region of spacer 160 can match the hollow interior region of the geometric profiles so that the geometric profiles and spacer form one smooth elevation throughout the interior of the modular light fixture assembly, i.e., there is a uniform interior cross-sectional shape. A user and manufacturer will appreciate this uniform interior as these interior surfaces may enable a more efficient arrangement for the light source, and/or it may achieve better reflection/refraction from the light by avoiding sharp angles and different interior profiles.

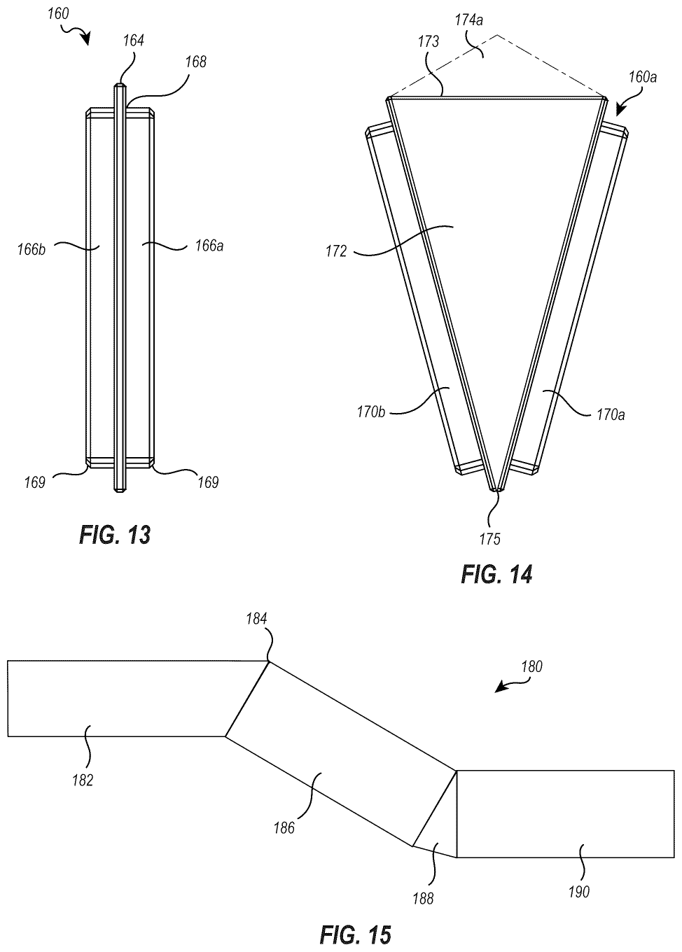

FIG. 13 is a side view of a spacer 160 according to embodiments of the present disclosure. The spacer has a flange 164, a first plug 166a, and a second plug 166b. Flange 164 has corner 168 that is formed between flange 164 and either the first or second plug. Corner 168 can abut the end of a geometric profile when they are assembled. Corner 168 can be a relatively sharp corner, so the transition between the end of the geometric profile and corner 168 is as small and invisible as possible or corner 168 can be angled or rounded to correspond to an angle or rounding on the end of the geometric profile. The plugs 166a and 166b also have corners 169 that are more rounded to facilitate insertion into the end of the geometric profiles. An assembler will appreciate the rounded nature of corners 169 as it broadens the tolerances and smoothens the installation process.

Angles between geometric profiles can be provided in any number of different ways to provide a seamless appearance. In one example, the geometric profiles 104 can be customized to create a wedge or other angled shape, such as shown by the shape in FIG. 14. Alternatively, the spacer 160 can be modified in depth and thickness to accomplish a similar objective. Along these lines, FIG. 14 is a side view of an example of an angled spacer 160a according to embodiments of the present disclosure. The angled spacer 160a includes a body 172 that has a triangular shape having an angle that will be the angle between adjacent geometric profiles in the final assembled modular light fixture. Body 172 has a similar fit with the end of a geometric profile as the linear spacers shown herein, and forms a seamless, small juncture between one or more geometric profiles. Angled spacer 160a includes plugs 170a and 170b that can operate the same way as the plugs on the linear spacers shown and described elsewhere herein.

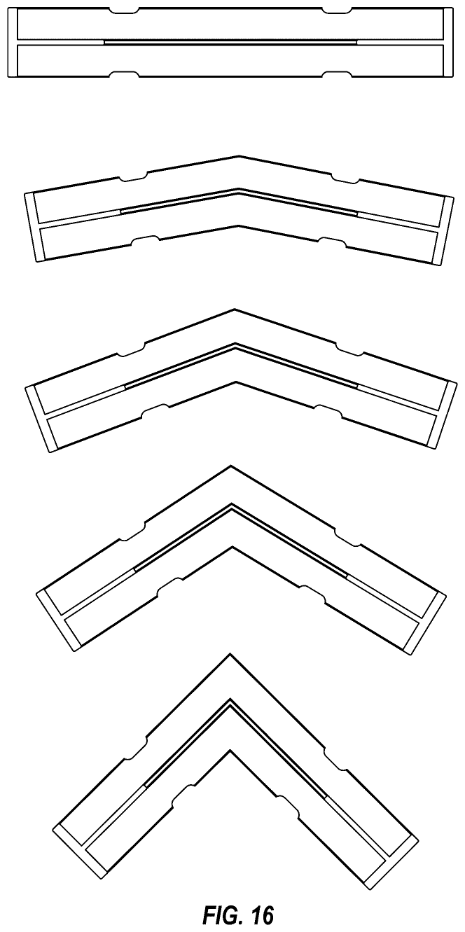

Body 172 has a wide end 173 between the sides of the angled spacer 160a that are more spaced apart than the other side. On the opposite side of body 172 is a narrow end 175. A manufacturer can construct a wide-end 173 that can have a flat, straight profile like that shown in FIG. 15 or a different shape depending on the manufacturer's specifications. In some embodiments, wide end 173 is an angled section 174 formed by two planes (phantom lines) that are parallel with the sides of the geometric profiles. The resulting structure has the appearance of a single geometric profile with a seamless and aesthetic angle, and the outer surface of the geometric profile reaches a point. Plugs 170b and 170a, by virtue of their insertion into the geometric profiles, prevent light from leaking out because there is no direct line of sight through the interface. In other embodiments, wide end 173 can have a rounded shape to give the appearance of a bent geometric profile with a continuous, pleasing shape.

FIG. 14 also shows that narrow end 175 can form a point like the embodiment shown here, such that the spacer (or, alternatively, a geometric profile) provides an overall angled appearance from a top-down view. In other embodiments, narrow end 175 does come to a point and instead can be an interior round or a flat. The angle between the two adjacent geometric profiles can be virtually any angle from 0 degrees to 180 degrees. For example, the connector, spacer, and geometric profiles can enable an angle that is about 0°, about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, about 150°, about 155°, about 160°, about 165°, about 170°, about 175°, or about 180°.

For each of these configurations involving an angled spacer or angled geometric profiles, an angled track connector 150 (See FIG. 16) can also be provided that has the same angles such that the track connector and spacer both accommodate the same angle between the adjacent geometric profiles in the modular light fixture. In some embodiments, the modular light fixture can be sold in units that include angled spacers and angled track connectors in pairs at known angles. It is also feasible for an infinite number of angled spacers, angled geometric profiles, and angled track connectors to suit any desired shape.

FIG. 15 is a top-down view of an assembled modular light fixture 180 according to embodiments of the present disclosure, which implements various angled connections. Modular light fixture 180 includes a first geometric profile 182, a first angled connection 184 (the connection between angled geometric profiles), a second geometric profile 186, an angled spacer 188 (or angled geometric profile), and a third geometric profile 190. The orientation of the angles of the adjacent geometric profiles can be up, down, left, right, or at some combination thereof relative to one another. In general, an assembler can position a first geometric profile adjacent to an angled one and use a standard spacer so that the joint between the linear and angled geometric profile appears to follow an angled pattern seamlessly. The next joint for each opposing end of a given geometric profile can similarly be joined by linear or angled geometric profiles, along with corresponding spacers and track connectors to achieve virtually any number of shapes or configurations.

In at least one embodiment, geometric profile 182 and angled connection 184 can be the joint between two geometric profiles (182 and 186). In such an embodiment, a standard or linear spacer, as previously discussed, can join the geometric profiles 186 and 182. Thus, a manufacturer can cut the ends of geometric profiles to cause them to mate seamlessly at a defined angle. Alternatively, an assembler can couple geometric profile 190 with angled spacer 188 and couple angles spacer 188 with geometric profile 190.

According to further embodiments of the present disclosure, a size-adjusting spacer can be used to transition between geometric profiles having different sizes and/or shapes. For example, a first geometric profile having a 2″×2″ square shape can employ a size-adjusting spacer to match with a geometric profile that is a 3″×3″ square shape. The size-adjusting spacer can have a 2″×2″ plug on the first side and a 3″×3″ plug on the second side. The body of such a spacer could provide a smooth, tapered, or angled transition between the different-sized geometric profiles.

The same can be accomplished by having shape-adjusting spacers. For example, a first geometric profile with a square cross-section can match a second one with a round cross-section. The flanges and plugs of the shape-adjusting spacer can have the appropriate dimensions. The transition region of the shape-adjusting spacer can be any shape. In some embodiments, a pleasing shape is achieved by constructing the shape-adjusting spacer to appear to flow naturally from the first shape to the other shape.

FIG. 16 illustrates a top-down facing view of exemplary track connectors 150c, 150d, 150e, and 150f, any of which may be used to join two geometric profiles as desired. In at least one implementation, the various different track connectors can be provided with the following exemplary angles: 90°, 108°, 120°, 135°, and 180° (straight). One will appreciate that other acute and/or obtuse angles between these listed angles are also possible.

The modular lighting fixtures of the present disclosure allow users to add modules linearly, at angles, or in other continuous configurations to create a continuous light. These modular lighting fixtures offer significant advantages in terms of flexibility, functionality, and aesthetics over conventional lighting solutions. Specifically, the adaptability of the modular light fixtures allows for renovations, additions, or changes in their space with relative ease. Users can design lighting configurations tailored to their spaces, whether they need a straight line of light for a hallway, an angular arrangement for accentuating architectural features, or a curved path to follow unique room layouts. This adaptability allows for creative lighting designs that enhance functionality and visual appeal. For example, in retail settings, modular lighting can highlight product displays in precise, dynamic ways, while in homes, it can create personalized ambiance in living rooms, kitchens, or other areas.

The scalability of modular lighting fixtures also provides practical advantages. Users can start with a smaller setup and expand the system as needed, making it cost-effective. This is particularly beneficial in evolving spaces like offices or event venues, where lighting needs may change over time. Modular light systems reduce the need to replace entire fixtures, as users can simply add or rearrange modules, making the solution more sustainable and long-lasting.

In addition to adaptability and scalability, modular lighting enhances ease of installation and maintenance. Many modular systems feature standardized connectors and easy-to-install components, reducing the time and effort required for setup. Furthermore, if a module needs replacement or repair, it can often be done without disrupting the entire system.

Finally, assemblers of the modular light fixtures of the present disclosure will appreciate the ease of installation provided by the modular design. An assembler can use two anchored cables to support an entire track length of present disclosure. Should a location not allow for optimal placement of the anchored cables, the tracks allow for a high degree of adjustability, letting support be had anywhere along the length of the track. In summary, modular lighting fixtures provide unmatched customization, scalability, and efficiency while enhancing aesthetics and performance.

The present invention may be embodied in other specific forms without departing from its spirit or essential characteristics. Aspects of the present disclosure described and shown with respect to a door can apply equally to walls and wall panels. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A modular light fixture, comprising:
a first track having an upper surface, a lower surface, and a gap;
a cable in a form of a wire, a rigid stem, or a set of mounting hardware that attaches a support structure to at least the first track;
a cable coupler configured to couple to the cable and to reside at least partially within the gap;
a first geometric profile fastened to the lower surface of the track, the geometric profile housing a light source;
a track connector having a first end and a second end, the track connector being configured to fit within the gap in the first track with the first end in the gap of the first track; and
a second track having a second gap, wherein the second end of the track connector fits within the second gap, the first and second tracks are aligned in an end-to-end configuration, and a second geometric profile is secured to the second track.

2. The modular light fixture of claim 1, wherein the gap splits the upper surface along its length.

3. The modular light fixture of claim 1, wherein:
the cable coupler is configured to slide within the gap of the first track or the gap of the second track; and
the cable coupler is permitted to slide along the gap of the first track or the gap of the second track when unsecured to adjust a position of the cable coupler relative to the first track or the second track and to hold a specific position when secured.

4. The modular light fixture of claim 1, further comprising:
a spacer between the first geometric profile and the second geometric profile, the spacer further comprising:
a flange;
a first plug extending toward the first geometric profile, the first plug being coupled to the first geometric profile, with an outer surface of the first plug interfacing with an interior surface of the first geometric profile;
a second plug extending toward the second geometric profile, the second plug being coupled to the second geometric profile, with an outer surface of the second plug interfacing with an interior surface of the first geometric profile;

5. The modular light fixture of claim 4, wherein an exterior surface of the flange forms a single elevation with the outer surface of the first geometric profile and the outer surface of the second geometric profile.

6. The modular light fixture of claim 4, wherein the spacer is at least partially translucent and configured to allow light to transmit through.

7. The modular light fixture of claim 4, wherein the track connector is angled and wherein the first track and second track are aligned together at an angle defined by the track connector.

8. The modular light fixture of claim 7, wherein the flange is a body with an angle that spans between the first and second geometric profiles.

9. The modular light fixture of claim 1, wherein the track connector is t-shaped and comprises:
a plate having a top face and one or more tapered edges;
a tab that protrudes perpendicularly away from the top face of the plate; and
one or more notch.

10. The modular light fixture of claim 1, wherein:
at least one of the first or second geometric profiles comprises an angled end; and
the alignment with the other of the first or second geometric profiles, and a corresponding track connector provides an angled modular light fixture.

11. The modular light fixture of claim 1, wherein the first geometric profile is at least partially translucent and configured to allow light to transmit through.

12. The modular light fixture of claim 1, wherein the first track comprises a first rail, a second rail, and a bridge that together define the gap.

13. The modular light fixture of claim 12, wherein the first rail and the second rail each have one or more hole, and the hole is configured to receive a fastener to secure the first geometric profile.

14. A modular light fixture, comprising:
a first track having a first gap defined by a first rail, a second rail, and a bridge;
a second track having a second gap defined by a third rail, a fourth rail, and a second bridge;
a track connector having a plate with a top face, a first tapered edge, a second tapered edge and a tab that protrudes perpendicularly away from the top face of the plate; and
a first geometric profile has one or more walls, wherein an opening is defined by the one or more walls.

15. The modular light fixture of claim 14, wherein the first tapered edge of the track connector resides at least partially within the first gap and the second tapered edge of the track connector resides at least partially within the second gap.

16. The modular light fixture of claim 14, wherein the tab extends vertically between the first and the second rail, as well as vertically between the third and fourth rail.

17. The modular light fixture of claim 14, wherein the first bridge extends at least partially into the opening.

18. The modular light fixture of claim 14, further comprising a cable coupler configured to be selectively secured at any point along the first gap or the second gap.

19. The modular light fixture of claim 14, wherein the first geometric profile is coupled to both the first track and the second track.

20. A modular light fixture, comprising:
a first geometric profile having a generally uniform cross-sectional shape and a first hollow interior;
a second geometric profile having the generally uniform cross-sectional shape and a second hollow interior;
a first light source in the first geometric profile;
a second light source in the second geometric profile;
a spacer between and coupled to the first geometric profile and the second geometric profile, the spacer having:
a flange having an exterior dimension that substantially matches the exterior dimension of the first geometric profile and the second geometric profile;
a first plug extending toward the first geometric profile, the first plug being coupled to the first geometric profile and at least partially residing in the hollow interior of the first geometric profile; and
a second plug extending toward the second geometric profile, the second plug being coupled to the second geometric profile and at least partially residing in the hollow interior of the first geometric profile; and
a power source coupled to the first and second light source and is configured to illuminate through the first geometric profile and the second geometric profile.
